(19) United States
(12) Patent Application Publication
(10) Pub. No.: US 2005/0108026 A1
(43) Pub. Date: May 19, 2005

(54) Personalized subtitle system

(76) Inventors: Arnaud Brierre, Los Angeles, CA (US); Gregor Holland, Venice, CA (US)

Correspondence Address: CHRISTIE, PARKER & HALE, LLP, PO BOX 7068, PASADENA, CA, 91109-7068, US

(21) Appl. No.: 10/713,570

(22) Filed: Nov. 14, 2003

(51) Int. Cl. G06F 17/60

(52) U.S. Cl. 705/1

(57) ABSTRACT

A personalized subtitle system. A personalized subtitle system includes a display device, such as a Heads Up Display (HUD) device, worn or carried by a user in a public venue such as a movie theater, playhouse, or stadium. The user utilizes the display device to select and read captioning or subtitle information for a public event such as a movie, play, or sporting event. In this way, subtitles in a variety of languages can be supplied for the public event. In another embodiment, the display device is used in conjunction with a conventional subtitle display system, such as a DVD player for home use. In either embodiment, the user can operate a control panel to select a desired language. Subtitles in the selected language are then displayed to a viewer wearing or using the display device. In this way, a viewer desiring subtitles may have subtitles displayed without disrupting another viewer's enjoyment of a public venue.

### BACKGROUND OF THE INVENTION

This invention pertains generally to providing subtitles and more specifically to providing subtitles personalized for a user.

Since the emergence of consumer digital media, such as the Compact Disc (CD) introduced in the 1980's, the trend towards digitization of media has continued unabated. The Digital Video Disk (DVD) platform has experienced an unprecedented adoption rate and the digital production, formatting, distribution and archiving of a vast majority of all media is likely to accelerate. Concurrently, the advent of broadband Internet services, digital television, digital streaming media, and a myriad of digital player devices have increased the viability for the commercial distribution of media without physical packaging. The emerging trend is towards streaming digital channels and the building of Personal Media Libraries and away from analog broadcast consumption. Predictions of the eventual obsolescence of the CD and DVD have begun to surface.

While all of these factors, along with a general globalization trend, have served to increase the distribution and availability of media, the potential for providing universal access, and adding value and enhanced content to media has yet to be realized. For example, the text associated with media, i.e. subtitles and lyrics, are either available in only limited fashion, or not available at all. If translation via subtitles were more readily available to accompany associated media, a larger global audience would be able to enjoy content from sources all around the world. Additionally, an archival system containing the subtitles, lyrics, and transcripts of media will allow for new forms of content search and the emergence of new educational and commercial opportunities enabled by such a feature.

Therefore a need exists for computer programs, systems, and protocols that allow the archiving and delivery of (personally selectable) subtitles and other complementary data to media files for which there is a meaningful language component. Furthermore, a need exists to make such subtitles and other complementary data available both for media which has been downloaded and archived as well as media which is being downloaded, i.e. experienced live or streamed, whether from a pre-recorded event, or from an actual real time event, personalized to the individual experiencing the media. Various aspects of the present invention meet such needs.

### SUMMARY OF THE INVENTION

In one aspect of the invention, a personalized subtitle system includes a Heads Up Display (HUD) worn by a user in a public venue such as a movie theater, playhouse, or stadium. The HUD is coupled to a personalized subtitle system controller that the user utilizes to control the operations of the personalized subtitle system. The user utilizes the HUD and personalized subtitle system controller to select and read captioning or subtitle information for a public event such as a movie, play, or sporting event. In this way, subtitles in a variety of languages can be supplied for the public event.

In another aspect of the invention, useful when a user is viewing pre-formatted presentations such as a movie in a theater, the subtitles are stored by the personalized subtitle system. Synchronization signals are transmitted by a cinema server to the personalized subtitle system controller via a wireless communications network in order to synchronize the pre-stored subtitles with presentation content.

In another aspect of the invention, the user provides a synchronization signal to the personalized subtitle system controller in order to synchronized pre-stored subtitles with presentation content.

In another aspect of the invention, the subtitles are transmitted as needed to the personalized subtitle system controller via a wireless communications network.

In another aspect of the invention, the personalized subtitle system is used in conjunction with a conventional subtitle display system, such as a DVD player for home use.

In another aspect of the invention, a user access a p subtitle server via a communications network to obtain subtitles. The subtitle server includes subtitles and associated metadata describing the subtitles. The user may then use the metadata in order to determine which subtitles to access.

### BRIEF DESCRIPTION OF THE DRAWINGS

These and other features, aspects, and advantages of the present invention will be more fully understood when considered with respect to the following detailed description, appended claims, and accompanying drawings, wherein:

FIG. 1a is a block diagram of a personalized subtitling system in accordance with an exemplary embodiment of the present invention;

FIG. 1b is a personalized subtitling system used for a cinema in accordance with an exemplary embodiment of the present invention;

FIG. 1c is a sequence diagram of a personalized subtitle system in accordance with an exemplary embodiment of the present invention;

FIG. 1d is a sequence diagram of the operation of a dynamic configuration process in accordance with an exemplary embodiment of the present invention;

FIG. 1e is a sequence diagram of the operation of a cinema server in accordance with an exemplary embodiment of the present invention;

FIG. 1f is a sequence diagram of the operation of a cinema server transmitting synchronization signals in accordance with an exemplary embodiment of the present invention;

FIG. 2 is a screen display from a personalized subtitle system controller in accordance with an exemplary embodiment of the present invention;

FIG. 3 is a block diagram of a personalized subtitling system having a separate input device in accordance with an exemplary embodiment of the present invention;

FIG. 4a is a hardware architecture diagram of a data processing system suitable for use as a personalized subtitle system controller in accordance with an exemplary embodiment of the present invention;

FIG. 4b is a hardware architecture diagram of a data processing system suitable for use as a cinema server in accordance with an exemplary embodiment of the present invention;

FIG. 5 is a block diagram of subtitle to content synchronization method wherein the subtitles are associated with presented content in accordance with an exemplary embodiment of the present invention;

FIG. 6 is process flow diagram of a personalized subtitle display process in accordance with the subtitle to content association method of FIG. 2;

FIG. 7 is a block diagram of subtitle to content synchronization method wherein presented content has an associated synchronization signal in accordance with an exemplary embodiment of the present invention;

FIG. 8 is a block diagram of subtitle to content synchronization method wherein a user supplies a synchronization signal in accordance with an exemplary embodiment of the present invention;

FIG. 9 is process flow diagram of a personalized subtitle display process in accordance with FIG. 4 and FIG. 5;

FIG. 10 is a block diagram depicting using the personalized subtitle system with a variety of enhanced content sources in accordance with an exemplary embodiment of the present invention; and

FIG. 11 is a block diagram depicting using the personalized subtitle system at a live event in accordance with an exemplary embodiment of the present invention.

### DETAILED DESCRIPTION

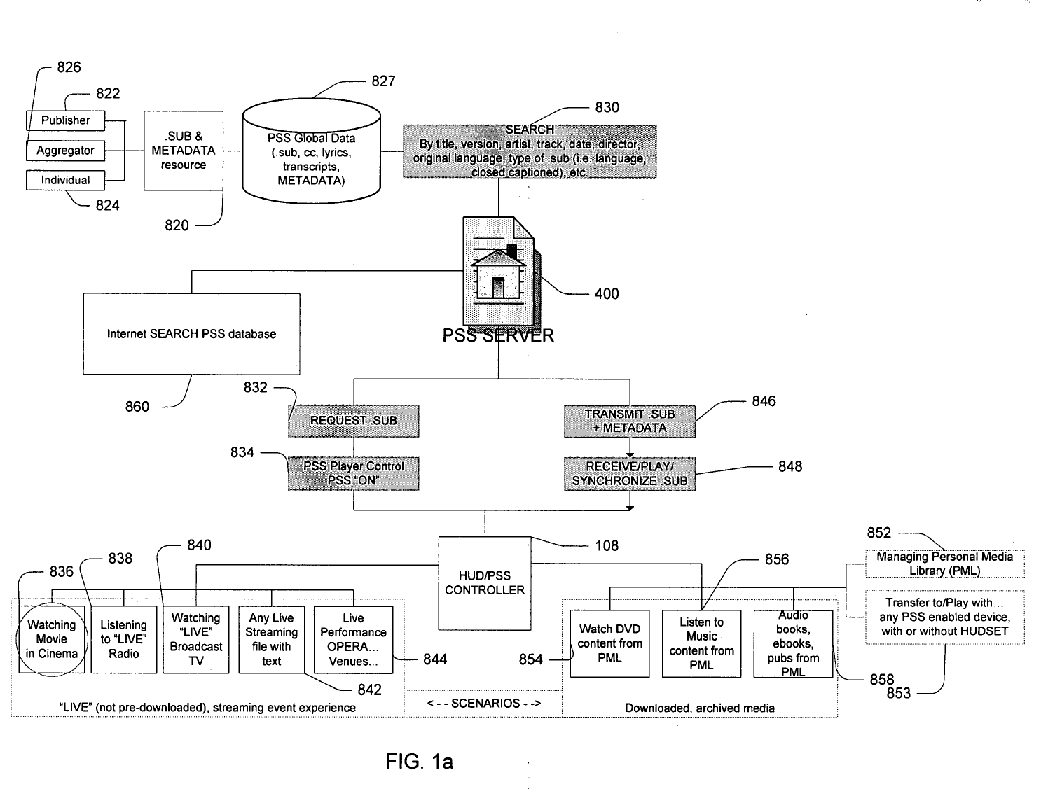

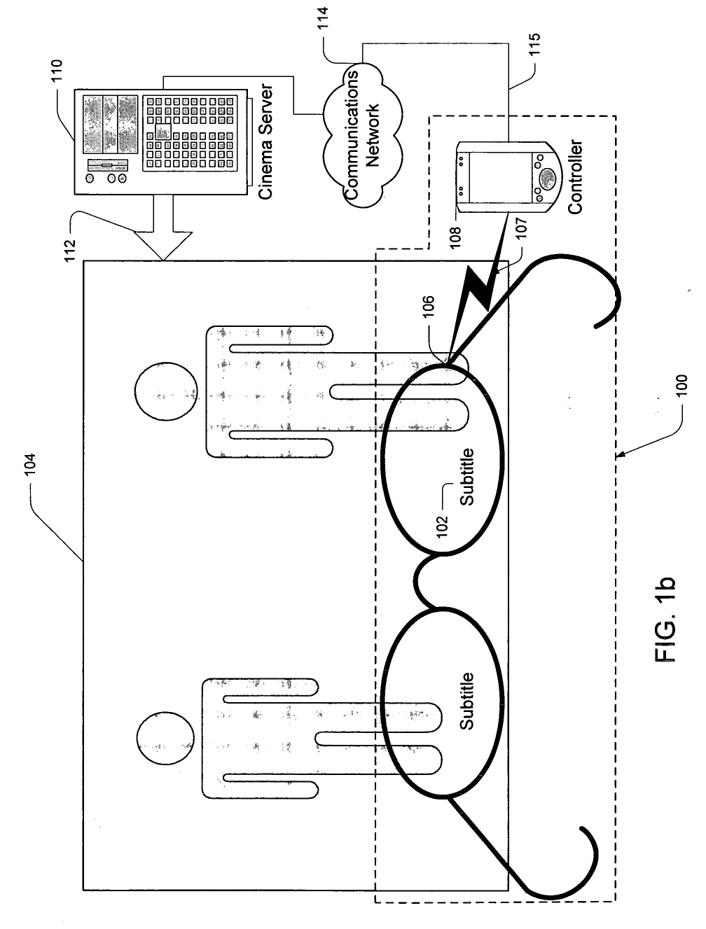

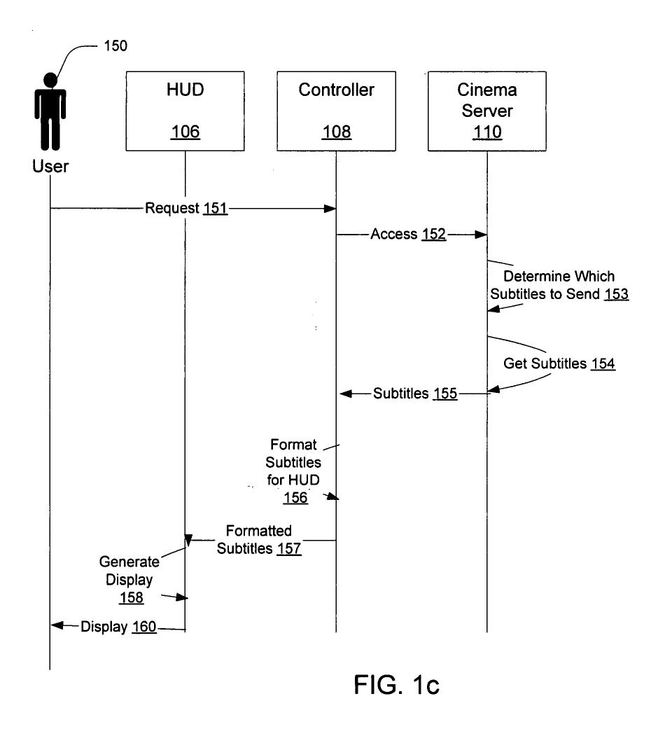

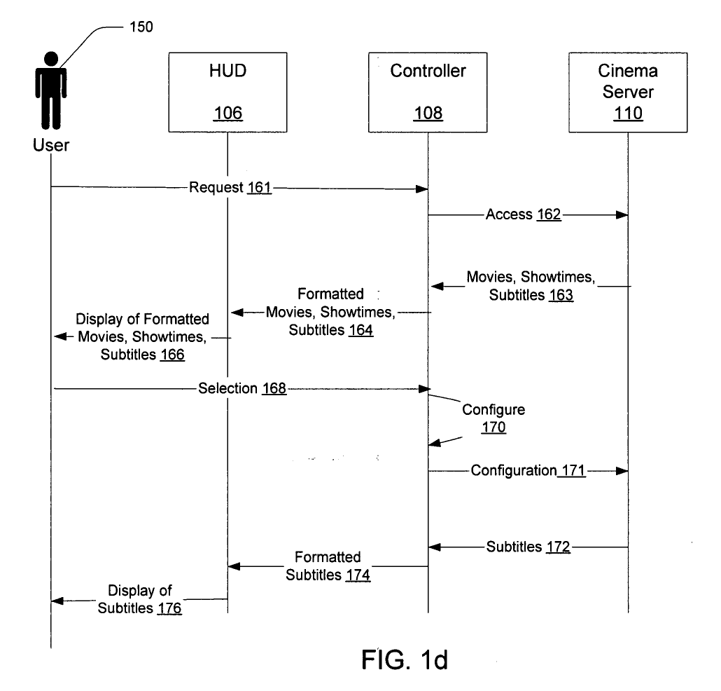

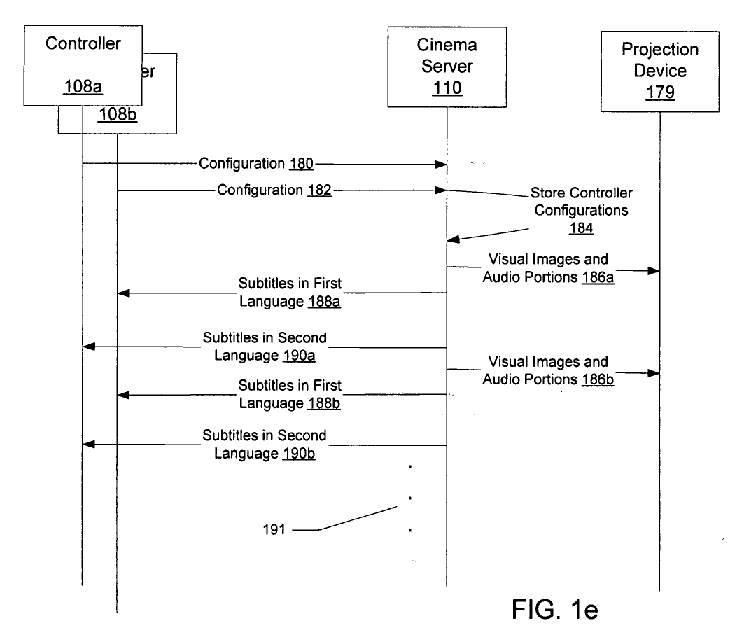

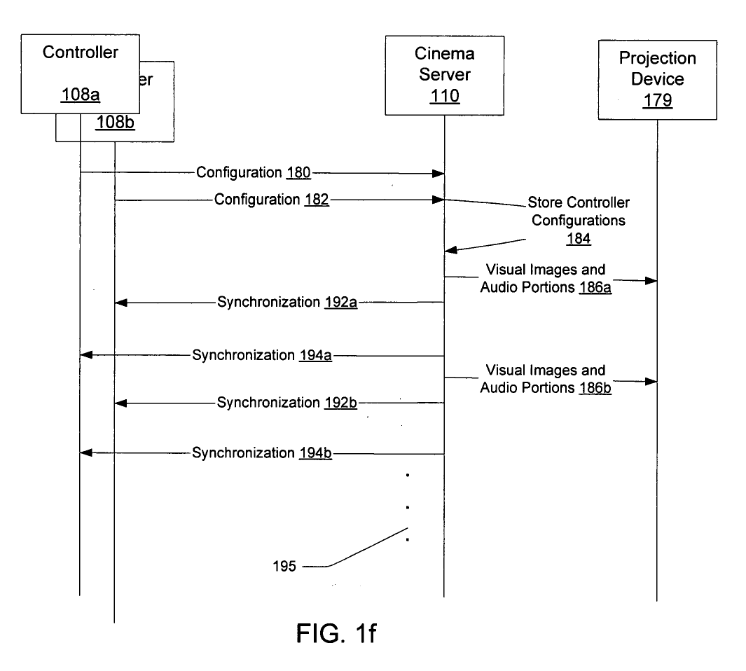

FIG. 1a is a block diagram depicting a personalized subtitle system incorporating a subtitle server in accordance with an exemplary embodiment of the present invention. A personalized subtitle system accesses a subtitle server 400 in order to obtain subtitles for various types of media. The subtitles are included in files that are herein termed “.sub” files in reference to their common three character extension. These .sub files may have internal formats that reflect the type of media that the .sub file is intended to be used with. For example, a sub file may be a text file associated with any media to which subtitles are to be added, such as movies, television shows, digital video discs, digital music files, radio shows, audio books, and other digital mediums.

The subtitle server may maintain a .sub file database 820 supplied with .sub files from a variety of sources. For example, .sub files may be generated and supplied by content publishers 822, individuals 824 who create sub files for altruistic or hobby purposes, and aggregators 826 who collect sub files for profit or other purposes. The subtitle server may also access more generalized metadata 827 such as data about closed captioning, lyrics, transcripts of public events, etc.

The content served by the subtitle server may be searched in a variety of ways. A user interface 830 provides searching by content title, artists or actors, audio tracks, versions, dates, directors, original languages, etc. The user interface may also allow more sophisticated queries such as allowing queries by type of subtitle needed, whether a .sub file, what language is needed, whether the material is from a closed caption or not, etc. A user using a personalized subtitle system uses the user interface to request (832) an appropriate .sub file which is then transmitted (846) to the personalized subtitle system for use. The personalized subtitle system receives (848) the .sub file and plays or synchronizes the .sub file with the associated media under the direction (834) of the user.

The personalized subtitle system may provide subtitles for a variety of media types. The personalized subtitle system may provide subtitles for watching a movie 836 as previously described. In addition, other types of “live” events may be supported, such as listening to live radio 838, watching a live television broadcast 840, viewing or listening to a live streaming file 842, live performances 844 at public venues, etc.

The personalized subtitle system may also provide management services 852 for managing a Personal Media Library (PML) including downloaded media files 850. The personalized subtitle system may transfer (853) the media files to other devices. A user utilizes the PML management services of the personalized subtitle system to present the media files such as watching videos 854, listening to music 856, listening to audio books, reading electronic books, etc.

The subtitle server may be coupled to a wide area network, such as the Internet. This allows conventional search engines 860 to search and index the content of the subtitle server for responding to Internet searches by users for .sub file content.

FIG. 1b is a block diagram of a personalized subtitle system used in a cinema in accordance with an exemplary embodiment of the present invention. A personalized subtitle system 100 provides subtitles 102 for viewing by a user while the user is viewing an entertainment production or other event, such as a movie 104 displayed in a movie theater. The subtitles are displayed on a display device, such as a Heads Up Display (HUD) device 106.

Suitable HUD devices are manufactured by The MicroOptical Corporation of Westwood, Mass., USA. Such a HUD device is a model The DV-1™ Wireless Digital Viewer mountable on eyeglasses or safety eyewear. The HUD device provides a monocular color quarter Video Graphics Adapter (VGA) image with a pixel format of 320 columns by 240 rows with a color depth of 12 bits. The DV-1™ displays bitmap graphics and text and the two modes can be overlaid. Communication between DV-1™ and other devices is achieved by establishing a linkage using a proprietary protocol over a Bluetooth™ wireless channel. The DV-1™ is battery operated.

The HUD device is coupled via communication link 107 to a personalized subtitle system controller 108 that includes functions for: controlling the operations of the HUD device; receiving subtitles; and receiving user inputs from the user. The personalized subtitle system controller may receive subtitles from a variety of sources. In one embodiment, the personalized subtitle system controller receives subtitles from a subtitle server, such as cinema server 110, that also supplies (112) the visual images and audio portions of the movie being viewed by the user. The personalized subtitle system controller couples (115) to the cinema server via a communication network, such as wireless communications network 114.

In a personalized subtitle system in accordance with an exemplary embodiment of the present invention, the personalized subtitle system is coupled to the cinema server using a communications network employing the IEEE 802.11 wireless Ethernet protocol commonly known as “Wi-Fi”. The personalized subtitle system controller is further coupled to the HUD device using a wireless communication link using a communication protocol such as Bluetooth.

FIG. 1c is a sequence diagram of a personalized subtitle system in accordance with an exemplary embodiment of the present invention. In operation, a user personalized subtitle system controller 108 receives a request 151 from a user 150 to access (152) a cinema server 110 associated with a movie that the user is viewing. In response to the request for access, the cinema server determines (153) which subtitles to transmit to the controller. The cinema server then gets (154) the appropriate subtitles 155, synchronized with the content of the movie, and transmits the subtitles to the personalized subtitle system controller. The personalized subtitle system controller uses the received subtitles to generate (154) formatted subtitles 156 for transmission to a HUD device 106. The HUD device receives the subtitles and uses the subtitles to generate 158 a subtitle display 160 for display to the user. The user may then view the subtitles and the movie simultaneously.

FIG. 1d is a sequence diagram of the operation of a dynamic configuration process in accordance with an exemplary embodiment of the present invention. In a dynamic configuration process, a personalized subtitle system controller 108 receives a request 161 from a user 150 to access 162 a cinema server 110. The cinema server returns event information 163 including a list of movies, what screens the movies are playing on, what times the movies are showing, what subtitles are available for each movie, and what channel or port each subtitle will be broadcast on. The controller formats the received information and transmits the formatted information 164 to a HUD device 106 for display to the user. The controller receives from the user a selection 168 indicating the movie and subtitles the user wants to view. The controller then configures (170) itself to receive the requested subtitles 172. To do so, the controller may transmit a controller registration 171 to the cinema server. The controller will receive subtitle packets for the desired subtitle by receiving on the appropriate channel or port. The controller automatically begins transmitting formatted subtitles 174 to the HUD device upon reception of the subtitle packets. The HUD device uses the formatted subtitles to generate a subtitle display 176 that is shown to the user either on the HUD display or by the controller.

In one personalized subtitle system in accordance with an exemplary embodiment of the present invention, the personalized subtitle system retains a default language setting. Through the use of the default language setting, subtitle files would automatically be in the default language unless specified.

FIG. 1e is a sequence diagram of the operation of a cinema server in accordance with an exemplary embodiment of the present invention. The cinema sever may serve subtitles to more than one personalized subtitle system controller, as exemplified by personalized subtitle system controllers 108a and 108b. The cinema server receives configuration information 180 and 182 from the personalized subtitle system controllers. The cinema server stores the personalized subtitle system controller configuration information. To play a movie, the cinema server transmits the visual images and audio portions 186a of the movie to a projection device 179. In addition, the cinema server transmits subtitles, 188a and 190a, associated with the visual images and audio portions to each of the personalized subtitle system controller. The process of transmitting visual images and audio portions to the projection device and transmission of associated subtitles is repeated continuously, as represented by visual images and audio portions 186b, subtitles 188b and 190b, and ellipses 191.

The subtitles may be transmitted in a variety of ways. In one personalized subtitle system in accordance with an exemplary embodiment of the present invention, the cinema server transmits packets that are specifically addressed for transmission to a specific personalized subtitle system controller on a network. To receive the packets, a personalized subtitle system controller registers itself with the cinema server so that cinema server knows what subtitles to transmit to the personalized subtitle system controller and what address to send them to.

In another personalized subtitle system in accordance with exemplary embodiments of the present invention, the cinema server sends out packets addressed to a special group address. Personalized subtitle system controllers that are interested in this group register to receive the subtitle packets addressed to the group when the user chooses a specific subtitle selection.

In another personalized subtitle system in accordance with an exemplary embodiment of the present invention, the cinema server sends out packets intended for transmission to all personalized subtitle system controllers on a network.

In another personalized subtitle system in accordance with an exemplary embodiment of the present invention, subtitles are assigned to a dedicated destination channel or port. In this embodiment, the personalized subtitle system controller does not need to do any filtering of the subtitles.

In another personalized subtitle system in accordance with an exemplary embodiment of the present invention, all subtitles are included in a single data stream addressed to the same destination channel or port. In this embodiment, the personalized subtitle system controller filters the received subtitle stream to identify the which portions of the subtitle stream includes the desired subtitles.

In another personalized subtitle system in accordance with an exemplary embodiment of the present invention, the cinema server transmits a single subtitle to a personalized subtitle system controller over a TCP stream. In this embodiment, the personalized subtitle system controller tells the cinema server what subtitle to transmit.

FIG. 1f is a sequence diagram of the operation of a cinema server transmitting synchronization signals in accordance with an exemplary embodiment of the present invention. The cinema sever may serve synchronization signals to personalized subtitle system controllers rather than complete subtitles to more than one personalized subtitle system controller, as exemplified by personalized subtitle system controllers 108a and 108b. In this embodiment, the subtitles are stored by each of the personalized subtitle system controllers for display to individual users. In operation, the cinema server receives configuration information 180 and 182 from the personalized subtitle system controllers. The cinema server stores (184) the personalized subtitle system controller configuration information. To play a movie, the cinema server transmits visual images and audio portions 186a of the movie to a projection device 179. In addition, the cinema server transmits synchronization signals, 192a and 194a, associated with the visual images and audio portions to each of the personalized subtitle system controller. The process of transmitting visual images and audio portions to the projection device and transmission of associated subtitles is repeated continuously, as represented by visual images and audio portions 186b, synchronization signals 192b and 194b, and ellipses 195.

In another personalized subtitle system in accordance with an exemplary embodiment of the present invention, the personalized subtitle system controller auto-discovers movies, display times, screen locations, and available subtitles when a user walks into the specific movie seating area or lobby.

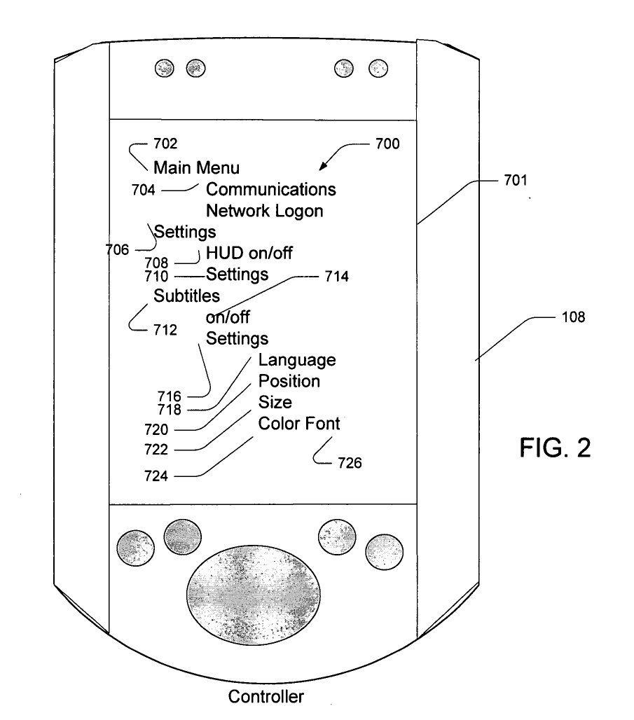

FIG. 2 is a screen display from a personalized subtitle system controller in accordance with an exemplary embodiment of the present invention. A personalized subtitle system controller 108 includes a screen display 700 for display of a menuing system 701 used by a user to control the operations of a personalized subtitle system controller. The menuing system includes a “Main Menu” menu 702 that offers a user a communication network logon selection 704. Once the user accesses the communications network, the user may then access a subtitle server or a cinema server via the communication network as previously described. The menuing system further includes a “Settings” submenu 706 having a “HUD on/off” 708 selection for turning the HUD device on or off and a “Settings” selection 710 for setting various options of the HUD device.

The menuing system further includes a “Subtitles” submenu 712. The Subtitles submenu includes an “on/off” selection 714 for turning the display of subtitles on and off. The Subtitles menu further includes a “Settings” submenu 716 having a “Language” selection 718 for selecting which language subtitles will be displayed in. The Settings submenu further includes a “Position” selection 720 for adjusting the position of the subtitles displayed by the HUD device. The Settings submenu further includes a “Size” selection 722 for setting the size of the subtitles displayed by the HUD device. Finally, the Settings submenu includes a “Color” selection 724 for setting the color of the displayed subtitles and a “Font” selection 725 for selecting a font for the displayed subtitles.

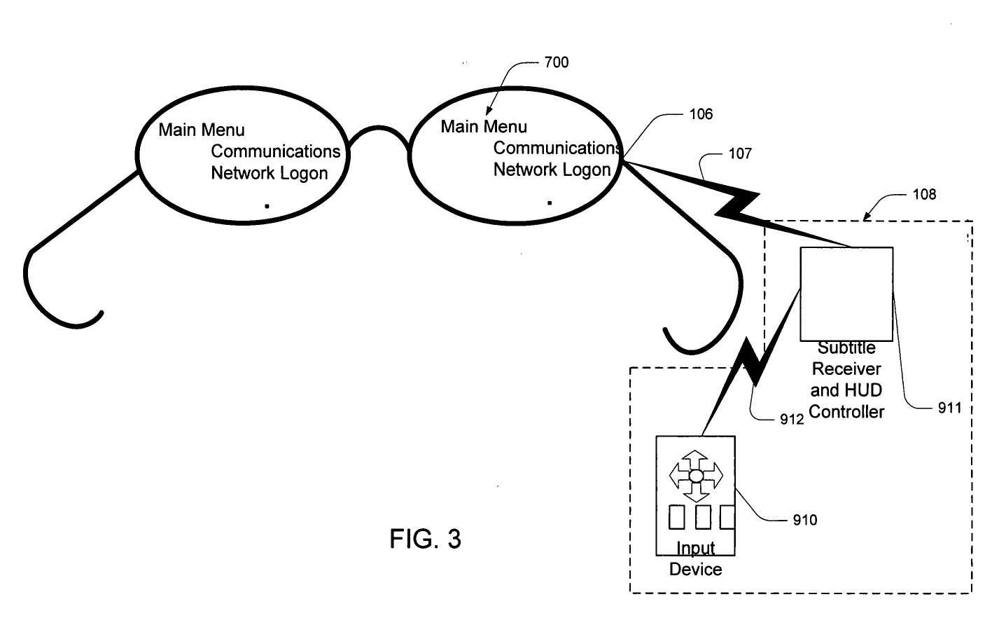

FIG. 3 is a block diagram of a personalized subtitle system having a separate input device in accordance with an exemplary embodiment of the present invention. In this embodiment, the personalized subtitle system controller 108 includes separate components that are coupled via short range communications links. The user utilizes an input device 910 coupled to a subtitle receiver and HUD controller 911 via a short-range communications link 912 such as a Bluetooth communications link. In operation, the personalized subtitle system controller displays previously described menu information 700 to the user using the HUD device 106 via a communications link 107. In response to the menu information, the user utilizes the input device to navigate through the menu system.

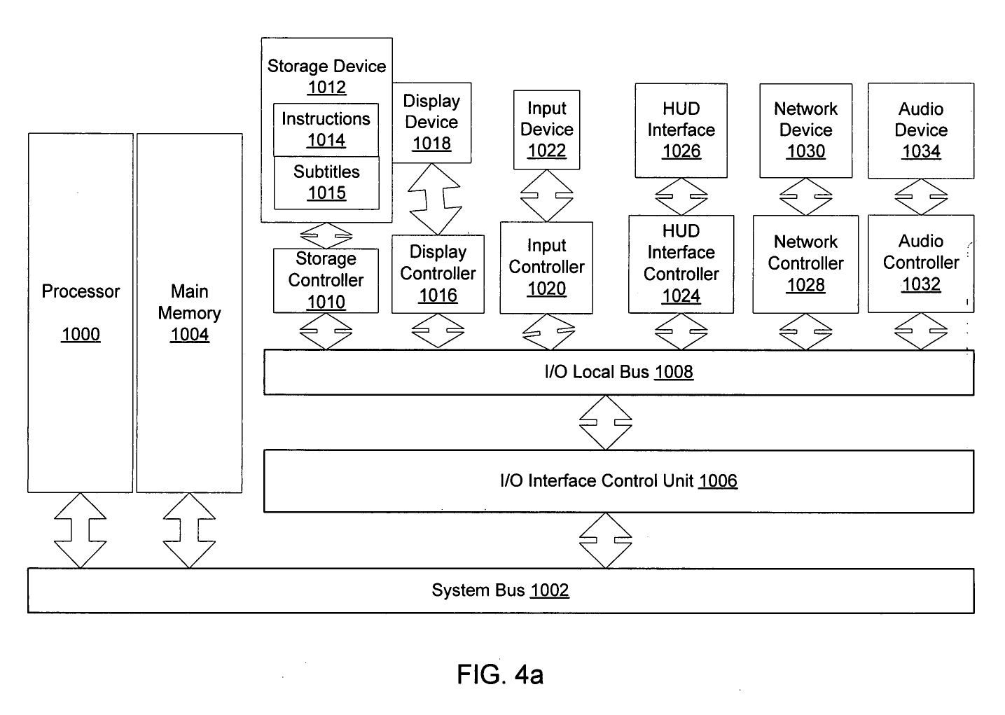

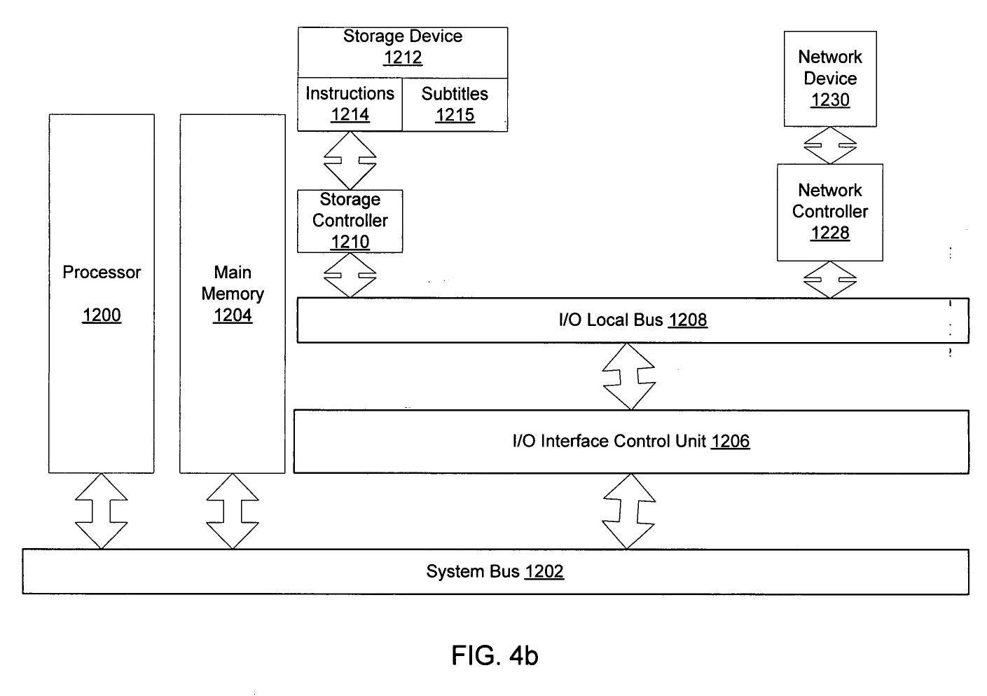

FIG. 4a is a hardware architecture diagram of a data processing system suitable for use as a personalized subtitle system controller in accordance with an exemplary embodiment of the present invention. A data processing system includes a processor 1000 operatively coupled via a system bus 1002 to a main memory 1004 and an I/O interface control unit 1006. The I/O interface control unit is operatively coupled via an I/O local bus 1008 to a storage controller 1010. The storage controller is operatively coupled to a storage device 1012. Computer program instructions 1014 implementing a personalized subtitle system are stored on the storage device until the processor retrieves the computer program instructions and stores them in the main memory. The processor then executes the computer program instructions stored in the main memory to implement a previously described personalized subtitle system to display subtitles to a user.

The personalized subtitle system controller further includes a display device 1018 coupled to the I/O local bus via a display controller 1016. The display device may be integral to the subtitle system controller such as display 700 of FIG. 2. The personalized subtitle system controller uses the display controller and display device to display portions of a personalized subtitle system user interface to a user.

The personalized subtitle system controller further includes an input device 1022 coupled to the I/O local bus via an input controller 1020. An input device may be integral to the subtitle system controller as illustrated by controller 108 of FIG. 2 or may be a separate device, such as input device 910 of FIG. 3. A user may use the input device to transmit synchronization signals to the personalized subtitle system controller as previously described. In addition, the user may use the personalized subtitle system controller to provide user inputs in response to the display portions of the user interface generated by the personalized subtitle system controller.

The personalized subtitle system controller further includes a HUD interface 1026 coupled to the I/O local bus via a HUD controller 1024. The personalized subtitle system controller uses the HUD interface to transmit subtitles to the HUD device as previously described. In one HUD device in accordance with an exemplary embodiment of the present invention, the HUD device includes a wireless communications link for receiving subtitles from the personalized subtitle system controller. In this embodiment, the HUD interface includes a wireless communications device. In another HUD device in accordance with an exemplary embodiment of the present invention, the HUD interface is directly coupled to the personalized subtitle system controller.

The personalized subtitle system controller further includes a network device 1030 coupled to the I/O local bus via a network controller 1028. The personalized subtitle system controller uses the network device to access a communications network and communicate with various sources of subtitles as previously described.

The personalized subtitle system controller may further include an audio device 1034 coupled to the I/O local bus via an audio controller 1032. The personalized subtitle system controller uses the audio device to present audio information to a user as previously described.

In one personalized subtitle system controller in accordance with an exemplary embodiment of the present invention, the subtitle controller includes subtitles 1015 stored in the memory storage device. These subtitles are displayed to a user in response to synchronization signals received by the personalized subtitle system controller.

FIG. 4b is a hardware architecture diagram of a data processing system suitable for use as a subtitle server in accordance with an exemplary embodiment of the present invention. A data processing system includes a processor 1200 operatively coupled via a system bus 1202 to a main memory 1204 and an I/O interface control unit 1206. The I/O interface control unit is operatively coupled via an I/O local bus 1208 to a storage controller 1210. The storage controller is operatively coupled to a storage device 1212. Computer program instructions 1214 implementing a subtitle server are stored on the storage device until the processor retrieves the computer program instructions and stores them in the main memory. The processor then executes the computer program instructions stored in the main memory to implement a previously described subtitle server to server subtitles 1215, stored on the storage device, to a personalized subtitle system.

The subtitle server further includes a network device 1230 coupled to the I/O local bus via a network controller 1028. The subtitle server uses the network device to access a communications network and communicate with personalized subtitle systems as previously described.

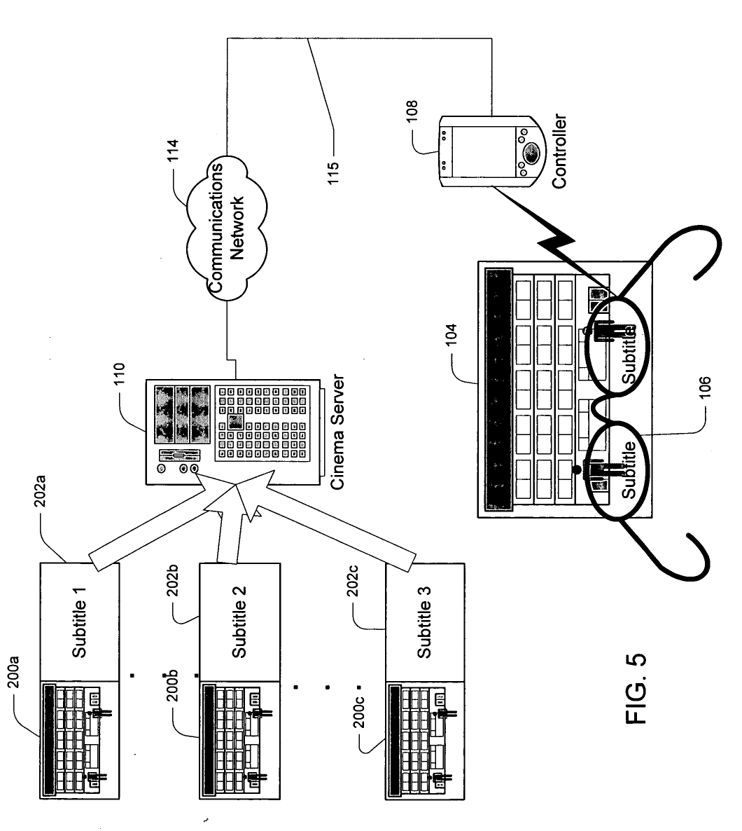

FIG. 5 is a block diagram of subtitle to content synchronization method wherein the subtitles are associated with presented content in accordance with an exemplary embodiment of the present invention. In this synchronization method, presentation content, such as movie frames 200a, 200b, and 200c is associated with subtitles, such as subtitles 202a, 202b, and 202c, stored in the cinema server 110. The personalized subtitle system controller is coupled to the cinema server via a communications network 114. As the cinema server retrieves the presentation content from memory and displays the presentation content on a theater screen 104, the cinema server also serves the associated subtitles to the personalized subtitle system controller 108. The personalized subtitle system controller receives the subtitles and then transmits the subtitles to the HUD device for display to the user. As the subtitles are associated with the presentation content and stored on the cinema server, the subtitles are inherently synchronized to the presentation content. In this embodiment, the cinema server only serves subtitles as they become available while reading and presenting the presentation content.

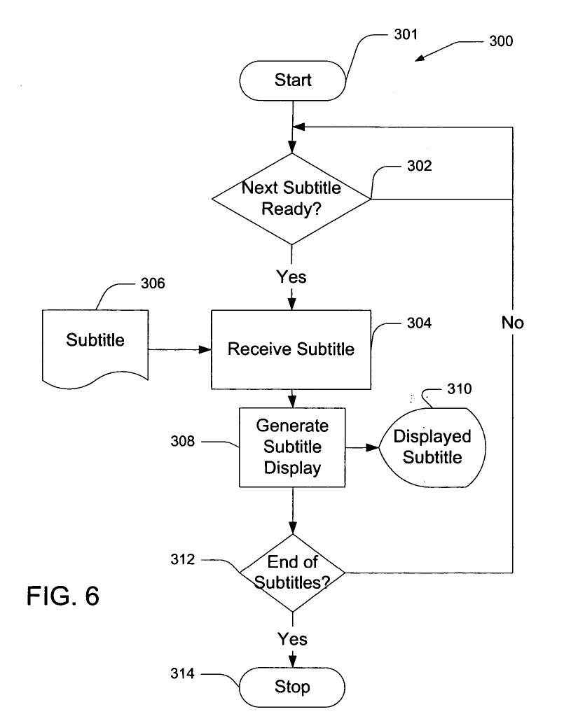

FIG. 6 is process flow diagram of a personalized subtitle display process in accordance with the subtitle to content association method of FIG. 5. On start up 301, a personalized subtitle display process 300 for subtitles associated with presentation content waits 302 until it is signaled by the cinema server that a next subtitle is ready. If the next subtitle is ready, the personalized subtitle display process receives 304 the next subtitle 306 from the cinema server and generates 308 a subtitle display 310 for presentation to the user. If the personalized subtitle display process determines 312 that there are no more subtitles to display, the personalized subtitle display process terminates 314. Otherwise, the personalized subtitle display process returns to its waiting state 302 and waits for the next subtitle to be transmitted by the cinema server.

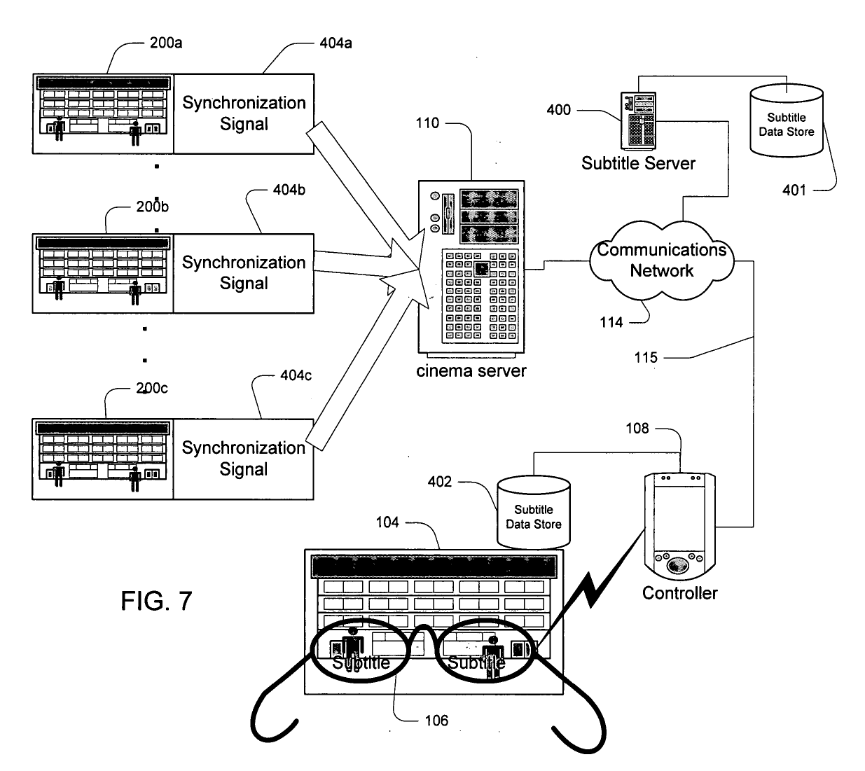

FIG. 7 is a block diagram of subtitle to content synchronization method wherein presented content has an associated synchronization signal in accordance with an exemplary embodiment of the present invention. In this synchronization method, the user utilizes the personalized subtitle system controller 108 to access a subtitle server 400 via the communications network 114. The subtitle server includes a subtitle database 401 having stored subtitles for a plurality of presentations such as movies. The user utilizes the subtitle server to specify a set of subtitles that are read from the subtitle database and stored in the personalized subtitle system controller's own subtitle datastore 402.

In this embodiment, the desired subtitle may not be available or supported by the cinema server and the movies it is playing. The personalized subtitle system controller can connect to a proxy subtitle service via the cinema server; tell the service what movie the personalized subtitle system controller needs a subtitle for, the movie version, what language the personalized subtitle system controller needs the subtitles in and other options like ‘closed caption’, ‘hearing impaired’, (i.e. types of .sub files for a particular language) etc.

The subtitle proxy service reads movie media file header, or other appropriate data source including user entered data to get the ‘version’ of the movie. The proxy service then searches the subtitle repositories and retrieves a suitable subtitle version for the movie version as version information for the subtitle file is included in the header or other appropriate data source. The subtitles are then written (via the TCP connection) back to the personalized subtitle system controller that stores the subtitles locally.

In one personalized subtitle system in accordance with an exemplary embodiment of the present invention, the above-described process is fully automated and occurs without a user's awareness that the subtitles were acquired using the proxy subtitle service. In this embodiment, the personalized subtitle system controller notifies the user that the subtitles being played are not being broadcast with the source media file, i.e. the movie. This is done in case of any error correction needed from the user.

Synchronization between the subtitles stored by the personalized subtitle system controller and the presentation content is provided by a plurality of synchronization signals, such as synchronization signals 404a, 404b, and 404c, associated with portions of the presentation content, such as movie frames of the presentation, such as frames 200a, 200b, and 200c. The presentation content and synchronization signals are stored in the cinema server 110. As the cinema server retrieves the presentation content from memory to generate the presentation 104 for the user, the cinema server also retrieves the associated synchronization signals. The cinema server then transmits the synchronization signals to the personalized subtitle system controller via the communications network. The personalized subtitle system controller uses the synchronization signals and the previously stored subtitles to generate an appropriate subtitle for transmission to the HUD device 106 and display to the user.

The actual format of the synchronization signal may vary. For example, in one personalized subtitle system in accordance with an exemplary embodiment of the present invention, the synchronization signal contains no additional information other than an indication that the next subtitle is to be displayed. In this embodiment, the synchronization signal operates as a timing signal used by the personalized subtitle system controller to time switching to the next subtitle. In other personalized subtitle systems in accordance with other exemplary embodiments of the present invention, the synchronization signal also includes an identifier, such as an index number or elapsed time code, of the subtitle that should be displayed upon receipt of the synchronization signal. In these embodiments, the personalized subtitle system controller uses the synchronization signal to find the exact subtitle to display each time a synchronization signal is received.

In another personalized subtitle system in accordance with an exemplary embodiment of the present invention, synchronization packets for a movie are transmitted from the cinema server to the personalized subtitle system controller as a time code encoding the elapsed playing time of the movie.

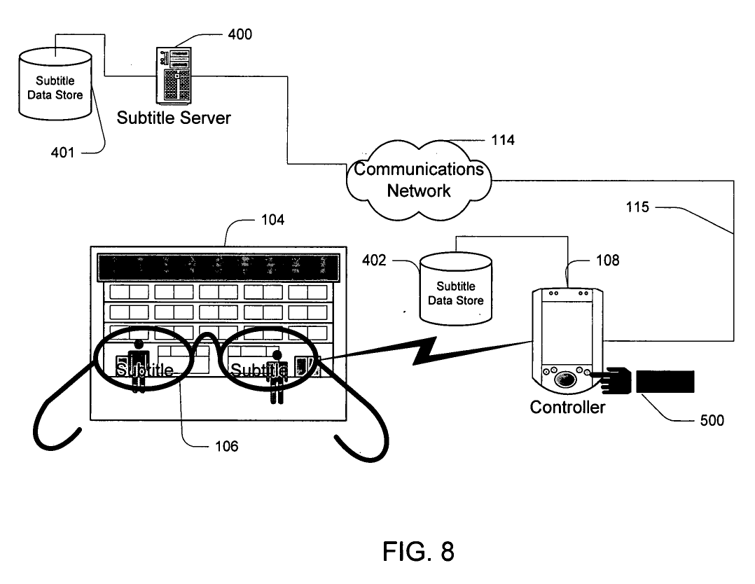

FIG. 8 is a block diagram of a subtitle to content synchronization method wherein the user supplies a synchronization signal in accordance with an exemplary embodiment of the present invention. In this embodiment, there may not be a cinema server. The user can download a desired subtitle onto a personalized subtitle system controller (for example, while still at home before attending the theatre) and bring it to the movie. In this embodiment, the user downloads a subtitle file manually onto their personalized subtitle system controller verifies that the version of the film and the version of the subtitle file are correctly matched. A personalized subtitle system website may facilitate the searching for subtitle files with version information for both the subtitle file and the media file to which the subtitle file is matched with. To use the subtitles, the user will manually ‘play’ the subtitle track. ‘Play’, ‘Fast Forward’, ‘Pause’, ‘Reverse’, and ‘Stop’ features are available to the user in the manual mode.

In slightly more detail, The user utilizes the personalized subtitle system controller 108 to access a subtitle server 400 via the communications network 114. The subtitle server includes a subtitle database 401 having store subtitles for a plurality of presentations such as movies. The user utilizes the subtitle server to specify a set of subtitles that are read from the subtitle database and stored in the personalized subtitle system controller's own subtitle datastore 402.

To use the subtitles, the user supplies a synchronization signal to the personalized subtitle system controller to input 500 the synchronization signal manually. In response to the manually input synchronization signal, the personalized subtitle system controller advances to the next subtitle to be displayed in sequence. Since the user is viewing the presentation content 104 at the same time as the subtitles, the viewer may increase or decrease the rate at which they supply the synchronization signal in order to advance or retard the timing of the transmission of subtitles to the HUD device 106.

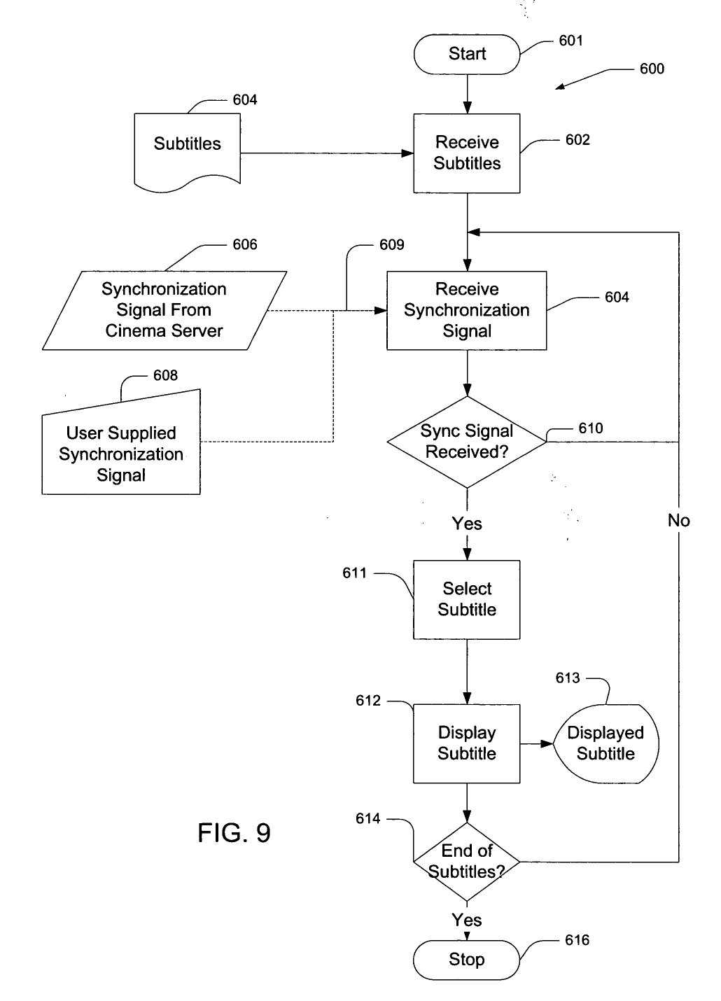

FIG. 9 is process flow diagram of a personalized subtitle display process in accordance with FIG. 7 and FIG. 8. The subtitle display process 600 starts (601) by receiving (602) subtitles from a subtitle server. The subtitle display process then waits to receive (604) a synchronization signal, such as cinema server synchronization signal 606 or user synchronization signal 608, indicating that the subtitle display process is to begin displaying subtitles. The type of synchronization signal that may be received by the subtitle display process is dependent upon what type of synchronization signals are available, as indicated by the dashed input line 609. As previously described, the synchronization signals may be associated with presentation content and transmitted to the subtitle display process or may be supplied by the user. If the synchronization signal is received (610) the subtitle display process selects (611) the subtitle to display and displays (612) the subtitle 613 using the previously described HUD device. If no synchronization signal is received, the subtitle display process continues to wait until a synchronization signal is received.

The selection of the next subtitle to display is dependent upon the type of synchronization signal sent. If the synchronization signal is a timing type signal received either from a cinema server or from a user's input, the next subtitle in a sequence of subtitles is selected for display. However, if the synchronization signal contains information about the next subtitle to display, the subtitle display process uses the synchronization signal to determine which subtitle should be displayed.

If the subtitle display process determines (614) that there are no more subtitles to display, the subtitle display process stops 616. Otherwise, the subtitle display process returns to its waiting mode until another synchronization signal is received.

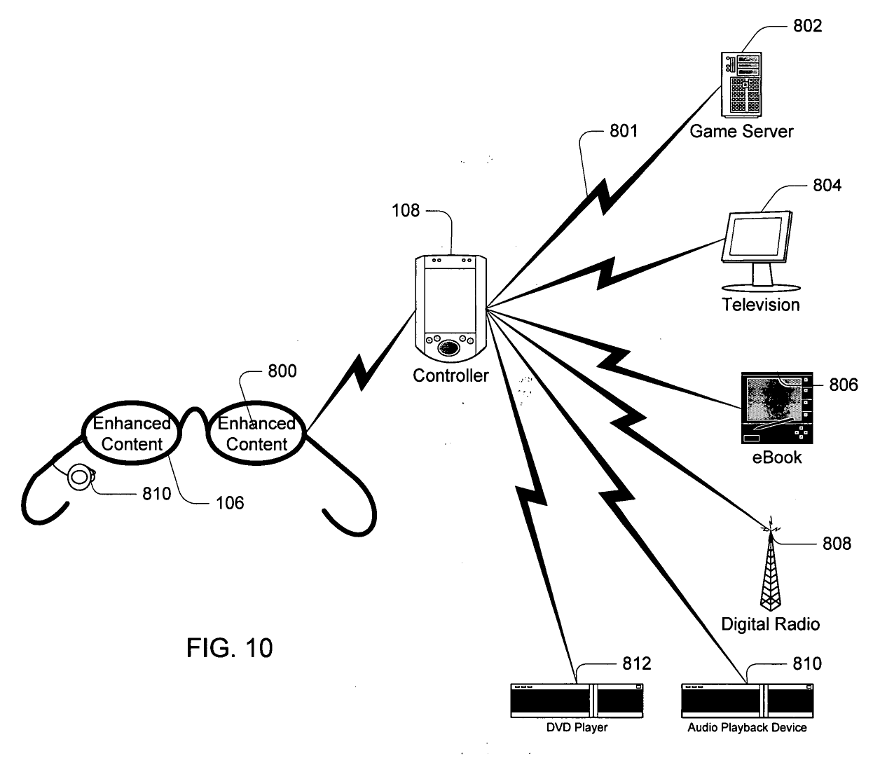

FIG. 10 is a block diagram depicting using the personalized subtitle system with a variety of enhanced content sources in accordance with an exemplary embodiment of the present invention. The personalized subtitle system controller 108 may include a short range wireless communications link 801, such as a communication link employing a Bluetooth protocol, as previously described. As such, the personalized subtitle system may be used with a variety of devices that are also capable of using a short range wireless communications link. These devices may act as a subtitle server for serving enhanced content such as subtitles to the personalized subtitle system. For example, a game server 802 may provide enhanced content 800 for a video game. The enhanced content is transmitted by the game server to the personalized subtitle system controller. The personalized subtitle system controller then transmits the enhanced content to the HUD device 106 for display to the user. Other devices may provide enhanced content as well. Enhanced content may come from a television display device 804. For example, a digital TV signal may include a subtitle data stream that may contain more information than a typical analog captioning signal. In addition, the subtitling information may be combined with a digital TV signal using a delayed playback device that stores the TV signal.

Enhanced content may also come from an electronic book display device 806, a digital radio broadcast 808, or an audio playback device 810. Other sources of enhanced content may be accommodated as well. For example, shopping kiosks, DVD players 812, and email display devices may all provide enhanced content for display to a user using a personalized subtitle system.

In another personalized subtitle system in accordance with an exemplary embodiment of the present invention, the HUD device includes an audio output device 810, such as an earphone, for presentation of audio content to the user. The enhanced content may then include an audio portion that is presented to the user by the personalized subtitle system controller using the HUD device's audio output device.

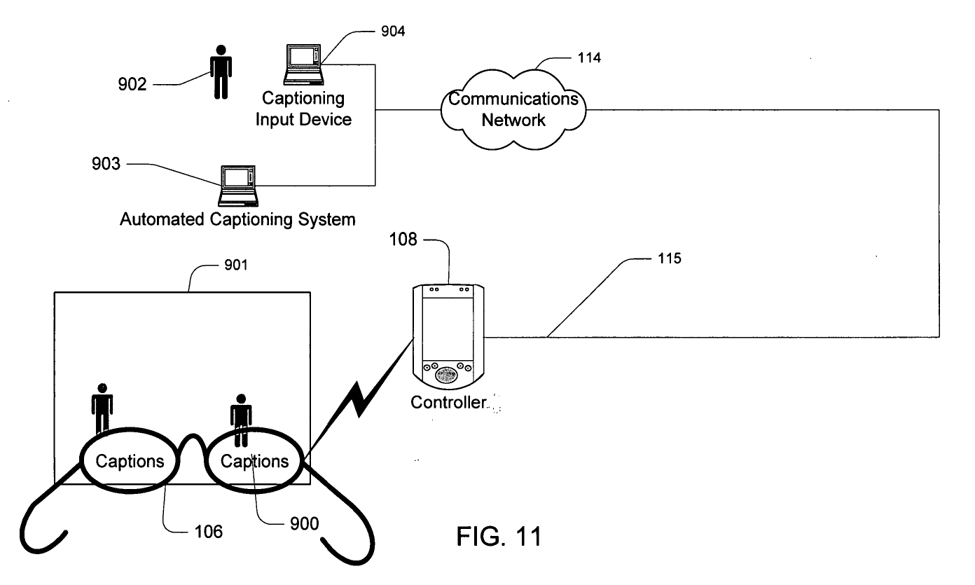

FIG. 11 is a block diagram depicting using the personalized subtitle system at a live event in accordance with an exemplary embodiment of the present invention. A user may use a personalized subtitle system to receive and display captioning 900 information for a live event 901. A transcriber 902 or a speech-to-text software program running on an automated captioning system 903 observes the live event and uses a captioning input device 904 to generate captions for the live event. A user using a personalized subtitle system controller 108 may then access (115) the captions via a wireless communications network 114. The personalized subtitle system controller then receives the captions from the captioning input device via the communications network and then transmits the captions to the HUD device for display to the user.

Although this invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by any claims supportable by this application and the claims' equivalents.

1. A personalized subtitle system, comprising:
a display device for display of subtitles; and
a personalized subtitle system controller coupled to the display device, the personalized subtitle system controller including:
a processor; and
a memory coupled to the processor, the memory having program instructions executable by the processor stored therein, the program instructions including:
accessing a subtitle server via a communications network;
receiving a subtitle from the cinema server via the communications network; and
displaying the subtitle on the display device.

2. The personalized subtitle system of claim 1, wherein the display device is coupled to the personalized subtitle system controller via a communication link, the program instructions for displaying the subtitle on the display device further including transmitting the subtitle to the display device.

3. The personalized subtitle system of claim 1, further comprising an input device coupled to the personalized subtitle system controller via communication link.

4. A personalized subtitle system, comprising:
a display device for display of subtitles; and
a personalized subtitle system controller coupled to the display device, the personalized subtitle system controller including:
a processor; and
a memory coupled to the processor, the memory having program instructions executable by the processor stored therein, the program instructions including:
accessing a subtitle server via a communications network;
receiving a plurality of subtitles from the subtitle server via the communications network;
receiving a synchronization signal;
selecting a subtitle from the plurality of subtitles using the synchronization signal; and
displaying the subtitle on the display device.

5. The personalized subtitle system of claim 4, wherein the program instructions for selecting a subtitle further include selecting a next subtitle from a sequence of ordered subtitles.

6. The personalized subtitle system of claim 4, wherein the synchronization signal is received from a user using an input device and the program instructions for selecting a subtitle further include selecting a next subtitle from a sequence of ordered subtitles.

7. The personalized subtitle system of claim 4, wherein the program instructions for receiving a synchronization signal further include:
accessing a cinema server using a wireless communication network; and
receiving the synchronization signal from the cinema server via the communication network.

8. The personalized subtitle system of claim 7, wherein the synchronization signal includes subtitle information and the program instructions for selecting a subtitle further include selecting a subtitle from the plurality of subtitles using the subtitle information.

9. The personalized subtitle system of claim 8, wherein the synchronization signal is a time code.

10. A personalized subtitle system, comprising:
display device means for display of subtitles; and
controller means coupled to the display device means, the controller means including:
cinema server accessing means for accessing a cinema server through a wireless communications network;
subtitle receiving means for receiving a subtitle from the cinema server via the wireless communications network; and
subtitle display means for displaying the subtitle on the display device means.

11. A method of displaying personalized subtitles on a display device, comprising:
accessing a subtitle server through a wireless communications network;
receiving a subtitle from the subtitle server through the wireless communications network; and
displaying the subtitle on the display device.

12. The method of displaying personalized subtitles on a display device of claim 11, wherein the display device is coupled to a personalized subtitle system controller via a wireless communication link, the method further comprising transmitting the subtitle to the display device by the personalized subtitle system controller.

13. The method of displaying personalized subtitles on a display device of claim 12, further comprising an input device coupled to the personalized subtitle system controller via wireless communication link.

14. A method of displaying personalized subtitles on a display device by a personalized subtitle system controller, comprising:
accessing by the personalized subtitle system controller a subtitle server via a communications network;
receiving by the personalized subtitle system controller a plurality of subtitles from the subtitle server via the communications network;
receiving by the personalized subtitle system controller a synchronization signal;
selecting by the personalized subtitle system controller a subtitle from the plurality of subtitles using the synchronization signal; and
displaying by the personalized subtitle system controller the subtitle on the heads up display.

15. The method of claim 14, wherein selecting a subtitle further includes selecting a next subtitle from a sequence of ordered subtitles.

16. The method of claim 14, wherein the synchronization signal is received from a user using an input device and selecting a subtitle further include selecting a next subtitle from a sequence of ordered subtitles.

17. The method of claim 14, wherein receiving a synchronization signal further includes:
accessing a cinema server using a wireless communication network; and
receiving the synchronization signal from the cinema server via the communication network.

18. The method of claim 17, wherein the synchronization signal includes subtitle information and selecting a subtitle further includes selecting a subtitle from the plurality of subtitles using the subtitle information.

19. The method of claim 18, wherein the synchronization signal is a time code.
